(19) United States
(12) Patent Application Publication
(10) Pub. No.: US 2020/0118471 A1
(43) Pub. Date: Apr. 16, 2020

(54) Automatic posting device for wall advertisement paper

(71) Applicant: Chun Liu, Foshan City (CN)

(72) Inventor: Chun Liu, Foshan City (CN)

(21) Appl. No.: 16/711,441

(22) Filed: Dec. 12, 2019

(30) Foreign Application Priority Data
Jun. 28, 2019 (CN) 2019105789083

(51) Int. Cl. G09F 15/02

(52) U.S. Cl. CPC G09F 15/025

(57) ABSTRACT

The invention relates to the field of advertisement posting, in particular to an automatic poster paper posting device, comprising a main body and a sliding frame which can be slid up and down above the main body, and an opening downward swing is arranged in the bottom wall of the sliding frame. A lifting device is provided in the top wall of the swinging cavity to drive the sliding frame to move up and down. The lifting device utilizes a threaded sleeve provided in the sliding frame to rotate forward and backward on the top wall of the fuselage. With a symmetrical first threaded rod, the present invention provides an automatic advertising device for wall advertising paper, which can realize the automatic posting of advertising paper. At the same time, an automatic gluing device is installed in the device to automatically apply the wall surface to be posted.

### CROSS-REFERENCES TO RELATED APPLICATIONS

The present application claims priority from Chinese application No. 2019105789083 filed on Jun. 28, 2019 which is hereby incorporated by reference in its entirety.

### FIELD OF TECHNOLOGY

The invention relates to the field of advertisement posting, and in particular relates to an Automatic posting device for wall advertisement paper.

### TECHNICAL FIELD

Due to the rich variety of goods nowadays, if you need to make your products known to consumers, you must increase advertising. Generally, there are TV media and paper advertisements. Traditional paper advertisements have great problems. Traditional The manual posting method has low efficiency and is prone to wrinkles, which leads to a great reduction in advertising effectiveness. Therefore, it is necessary to set up an automatic poster device for wall advertising paper to improve the above problems.

### CONTENT OF THE INVENTION

The purpose of the present invention is to provide an automatic wall advertisement paper posting device, which can overcome the above defects of the prior art, thereby improving the practicability of the device.

The technical solution adopted by the present invention to solve its technical problems is: an automatic wall advertisement paper posting device of the present invention includes a main body and a sliding frame which can be slid up and down above the main body, and the bottom wall of the sliding frame A swing cavity with an opening downward is provided, and a lifting device capable of driving the sliding frame to move up and down is provided in the top wall of the swing cavity, and the lifting device utilizes a threaded sleeve and the fuselage that are rotationally arranged in the sliding frame. The front and back symmetrical first threaded rods fixedly arranged on the top wall cooperate to drive the sliding frame to move up and down; a swinging frame is swingably arranged in the swinging cavity, and a gluing device is provided in the right end wall of the swinging frame. The gluing device accompanies the lifting device to drive the application wheel to apply the glue evenly on the wall surface. It is convenient for advertisement posting, a swinging device for swinging the swinging frame is provided in the right end wall of the swinging frame, and a first sliding cavity is symmetrically provided in the bottom wall of the swinging cavity, and the first sliding cavity and its end A posting device is provided in the wall, and the posting device includes a first sliding block slidably disposed in a first sliding cavity, and the first sliding block drives a roller provided in the bottom wall of the first sliding block to be rotatable. Move the advertising paper on the wall; an adsorption device is arranged in the bottom wall of the swing frame, and the adsorption device uses the sucker that is slidably arranged in the bottom wall of the swing frame to adsorb the advertisement paper, and then cooperates with the swing device to drive the advertisement paper from the horizontal direction to The vertical direction, so that the advertising paper is attached to the wall surface. A storage cavity with an upward opening is provided in the top wall of the fuselage, and a push plate is slidably arranged in the storage cavity. A hydraulic mechanism provided in the bottom wall of the storage cavity moves up and down under the action of the hydraulic mechanism, thereby driving the advertisement paper to move upward and cooperating with the adsorption device to adsorb the advertisement paper on the suction cup.

Advantageously, the lifting device further includes a transmission cavity provided in the top wall of the swinging frame, and a first rotation shaft extending forward and backward is rotatably provided in the transmission cavity, and the first rotation shaft in the transmission cavity is external to the first rotation shaft. A first bevel gear is fixedly disposed on the surface, and the front and rear ends of the first rotating shaft protrude from the outside of the swing frame and the first gear is fixedly disposed at the end. A switching cavity is provided in the bottom wall of the transmission cavity. A second rotating shaft is rotatably provided with the transmission cavity, and a second bevel gear meshing with the first bevel gear is fixedly disposed at an end of the second rotating shaft in the transmission cavity.

Beneficially, a front-rear symmetrical gear cavity is provided in the top wall of the swing cavity, a worm gear cavity is provided in one end wall of the gear cavity, and a first through the gear cavity is rotatably provided between the two front and rear worm gear cavities. A worm, a second gear meshing with the first gear is fixed on the outer surface of the first worm in the gear cavity, and a belt cavity is provided in the top wall of the worm gear cavity, and the belt cavity and the worm gear A third rotation shaft is provided for rotation between the cavities, a first worm gear meshing with the first worm is fixedly provided at the end of the third rotation shaft in the worm gear cavity, and an end of the third rotation shaft in the belt cavity is fixed A first pulley is provided, and the threaded sleeve penetrates the belt cavity. A second pulley is fixedly disposed on the outer surface of the threaded sleeve in the belt cavity, and the second pulley and the first pulley are provided. They are connected by belt drive cooperation. The threaded sleeve is provided with a first threaded hole penetrating up and down, and the first threaded rod is threadedly connected in the first threaded hole.

Beneficially, the glue coating device includes a guide groove with a rightward opening in the right end wall of the swinging frame, and a guide slider is slidably disposed in the guide sliding groove. A pressing spring is elastically provided between the left end wall of the guide chute, a rubber coating cavity is provided in the right end wall of the guide slider, and the application wheel is rotatably disposed in the rubber coating cavity. A through hole is provided in the top wall of the cavity, a glue storage tank is fixedly arranged on the top wall of the swinging frame, and a blanking hole is provided in the bottom wall of the glue storage tank to communicate with the glue coating cavity.

Advantageously, the swinging device includes an engaging cavity provided in the swinging frame, and a fourth rotating shaft rotatably provided in the engaging cavity, and the front and rear ends of the fourth rotating shaft are fixedly arranged in the swinging frame through the swinging frame. On the front and rear walls of the swing cavity, a second worm gear is fixedly disposed on the outer surface of the fourth rotating shaft in the meshing cavity, and a second worm meshing with the second worm gear is rotatably disposed in the meshing cavity. A second sliding cavity is disposed in the top wall of the switching cavity, a second sliding block is slidably disposed in the second sliding cavity, and a first motor is fixedly disposed in the bottom wall of the second sliding block. A third gear is fixedly arranged at the end of a motor output shaft. The second sliding block is provided with second threaded holes penetrating left and right, and a second threaded rod is internally connected to the second threaded hole. It is fixedly connected to the second worm, and the left end of the second threaded rod is dynamically connected to a second motor fixedly disposed in the left end wall of the second sliding cavity.

Advantageously, the posting device includes a third threaded hole provided in the first sliding block, which penetrates left and right, a third threaded rod is threadedly connected to the third threaded hole, and the end of the third threaded rod is deeply connected to the left and right. A third bevel gear is fixedly disposed in a rotation cavity provided between each of the first sliding cavities, and a fifth rotation shaft is disposed in rotation between the rotation cavity and the switching cavity. A fourth gear meshing with the third gear is fixedly provided at the end of the fifth rotating shaft, and a fourth bevel gear meshing with the third bevel gear is fixedly provided at the end of the fifth rotating shaft in the rotation cavity. The roller is rotated and disposed in a roller cavity provided in the bottom wall of the first sliding block.

Advantageously, the adsorption device comprises a plurality of first sliding holes distributed in a straight line and arranged symmetrically in the top wall of the swinging frame, and the first sliding holes are slidably provided with the first sliding holes fixedly connected to the suction cups. A sliding rod, a ventilation hole penetrating up and down is provided in the first sliding rod, a return spring is elastically provided between the first sliding rod and the top wall of the first sliding hole, and the left end of the first sliding hole is A communication pipe communicating with the outside is provided in the wall, a second sliding hole penetrating the communication pipe is provided in an end wall of one side of the first sliding cavity, and a second sliding rod is slidably provided in the second sliding hole. A first resetting device is elastically provided between the second sliding rod and an end wall of the second sliding hole, and an air hole penetrating vertically is provided in the second sliding rod.

Advantageously, the hydraulic mechanism includes a third sliding hole provided in the bottom wall of the storage cavity, and a third sliding rod fixedly connected to the pushing plate is slidably disposed in the third sliding hole, and A second reset device is elastically provided between the third sliding rod and the end wall of the third sliding hole. A fourth sliding hole with an upward opening is provided on the right side of the top wall of the fuselage, and the fourth sliding hole is slidable. A fourth sliding rod is provided, and a hydraulic pipe is provided between the fourth sliding hole and the third sliding hole. Beneficially, rollers are symmetrically arranged on the front and rear walls of the fuselage to facilitate the movement of the fuselage.

Beneficial effects of the present invention: An automatic poster device for wall advertisement paper provided by the present invention can realize the automatic posting of advertisement paper, and at the same time, an automatic gluing device is installed in the device, which can automatically apply glue to the wall surface to be posted. The posting device installed in the fuselage can drive the roller to roll the posted advertisement paper, thereby making the posted advertisement paper smoother. The setting of the invention is convenient to move, easy to operate, strong in functionality and good in stability. To facilitate production and promotion.

### BRIEF DESCRIPTION OF THE DRAWINGS

In order to more clearly illustrate the embodiments of the invention or the technical solutions in the prior art, the drawings used in the description of the embodiments or the prior art will be briefly introduced below. Obviously, the drawings in the following description are merely For some embodiments of the invention, for those skilled in the art, other drawings can be obtained based on these drawings without paying creative labor.

The invention is further described below with reference to the drawings and embodiments.

FIG. 1 is a schematic diagram of the overall structure of an automatic poster paper posting device according to the present invention.

FIG. 2 is a schematic diagram of an enlarged junction structure of A in FIG. 1.

FIG. 3 is a schematic enlarged view of B in FIG. 1.

FIG. 4 is a schematic structural diagram of C-C in FIG. 1.

FIG. 5 is a schematic structural diagram of D-D in FIG. 4.

### DETAILED DESCRIPTION OF THE INVENTION

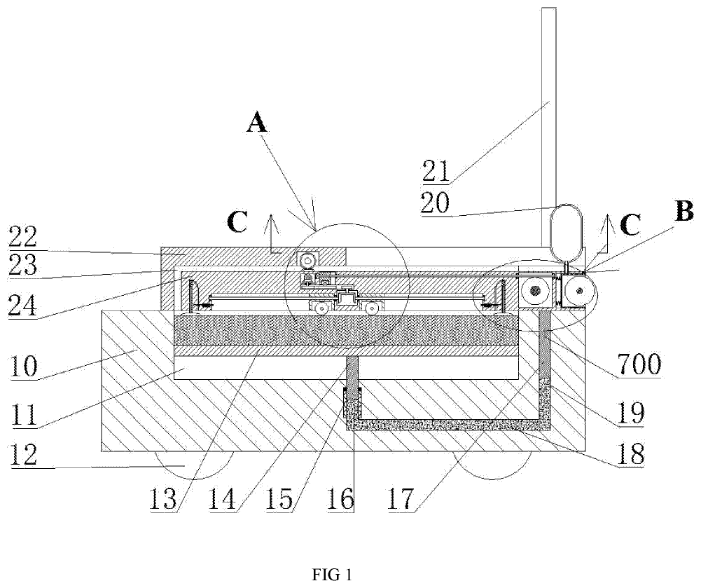

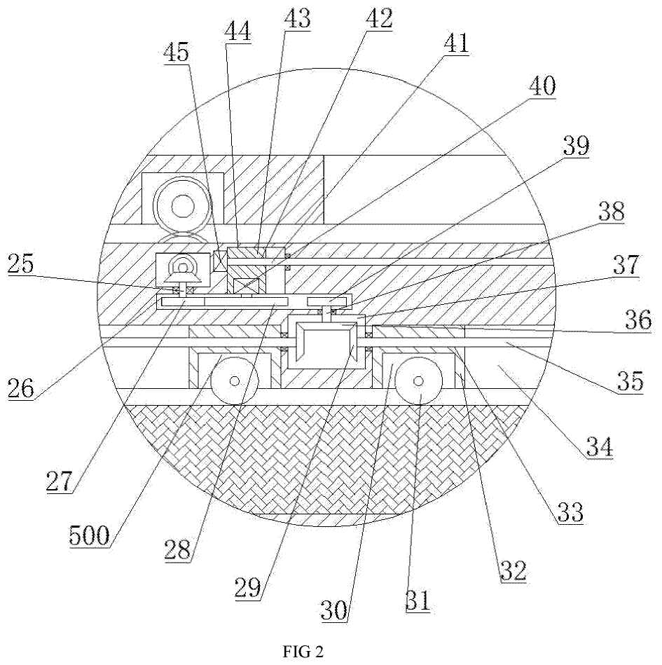

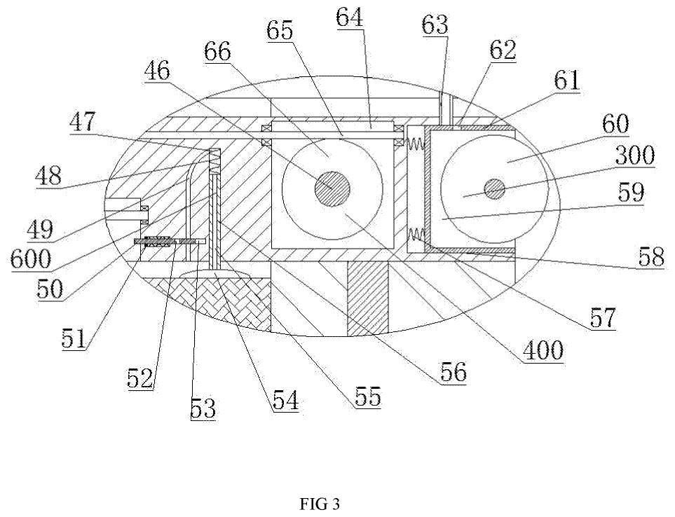

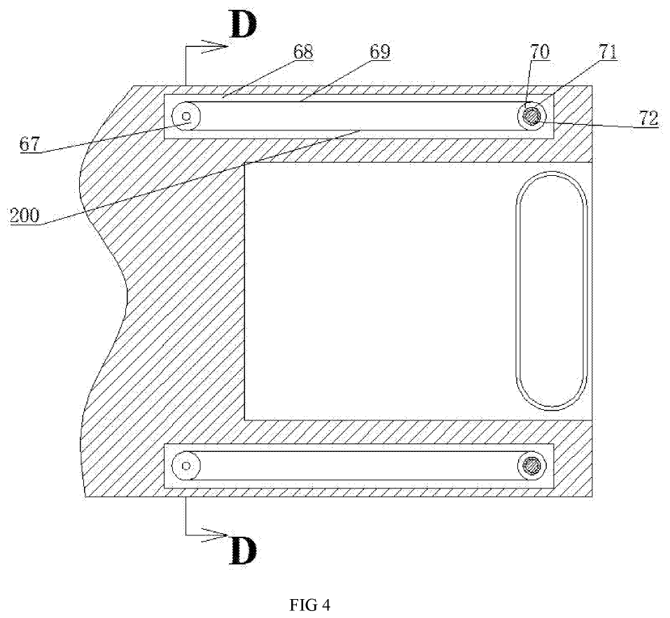

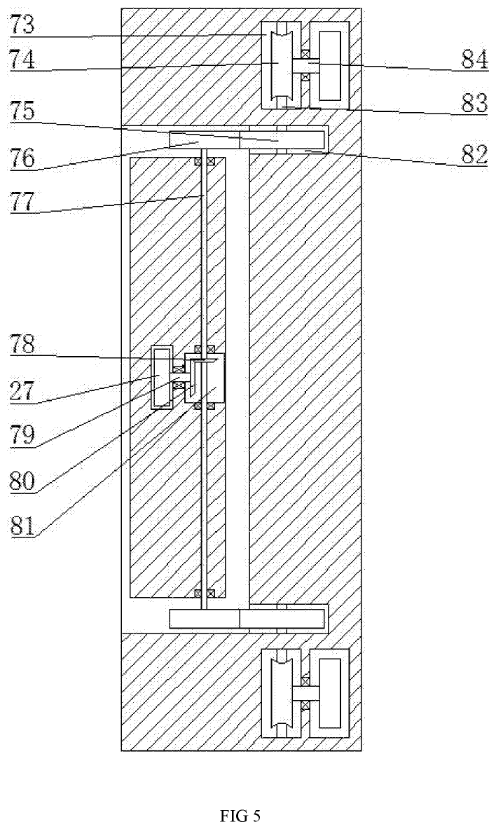

The present invention will be described in detail below with reference to FIGS. 1-5. Among them, for convenience of description, the orientation described below is defined as follows: the up-down, left-right, front-back direction described below is consistent with the up-down, left-right, front-back direction of the projection relationship of FIG. 1 itself.

An automatic advertisement wall posting device described in conjunction with FIGS. 1-5 includes a main body 10 and a sliding frame 22 that can slide up and down above the main body 10, and an opening is provided in the bottom wall of the sliding frame 22 A downward swing chamber 23 is provided in the top wall of the swing chamber 23 with a lifting device 200 capable of driving the sliding frame 22 to move up and down. The lifting device 200 utilizes a screw sleeve 71 and The front and rear symmetrical first threaded rods 21 fixedly arranged on the top wall of the fuselage 10 cooperate to drive the sliding frame 22 to move up and down; a swinging frame 24 is swingably disposed in the swinging cavity 23, and a gluing device 300 is disposed in the right end wall of the swinging frame 24. The gluing device 300 accompanies the lifting of the lifting device 200 to drive the application wheel 60 to The glue is evenly spread on the wall surface to facilitate advertisement posting. A swinging device 400 for swinging the swinging frame 24 is provided in the right end wall of the swinging frame 24, and a first slide is arranged symmetrically in the bottom wall of the swinging cavity 23 A cavity 24, and the first sliding cavity 24 and an end wall thereof are provided with a posting device 500, and the posting device 500 includes a first sliding block 32 slidably disposed in the first sliding cavity 24, the first sliding block 32 drives the roller 31 rotatably disposed in the bottom wall of the first sliding block 32 to move the advertising paper on the wall surface; an adsorption device 600 is provided in the bottom wall of the swing frame 24. The adsorption device 600 uses the suction cup 54 slidably disposed in the bottom wall of the swing frame 24 to adsorb the advertisement paper, and then cooperates with the swing device 400 to drive the advertisement. The paper is rotated from the horizontal direction to the vertical direction, thereby adhering the advertisement paper to the wall surface. A storage cavity 11 with an upward opening is provided in the top wall of the fuselage 10, and a push plate is slidably disposed in the storage cavity 11. 13. The pushing plate 13 is moved up and down by a hydraulic mechanism 700 provided in the bottom wall of the storage chamber 11, so as to drive the advertisement paper to move upward and cooperate with the adsorption device 600 to adsorb the advertisement paper on the suction cup.

Advantageously, the lifting device 200 further includes a transmission cavity 81 provided in the top wall of the swinging frame 24, and a first rotating shaft 77 extending forward and backward is rotatably disposed in the transmission cavity 81. A first bevel gear 78 is fixedly disposed on the outer surface of the first rotating shaft 77. The front and rear ends of the first rotating shaft 77 protrude from the outside of the swing frame 24 and the first gear 76 is fixedly provided at the end. The transmission cavity 81 A switching cavity 26 is provided in the bottom wall, and a second rotating shaft 25 is rotatably provided between the switching cavity 26 and the transmission cavity 81. The end of the second rotating shaft 25 in the transmission cavity 81 is fixedly provided with the second rotation shaft 25. The second bevel gear 80 meshed with the first bevel gear 78 is fixed with a second gear 27 at the end of the second rotating shaft 25 in the switching cavity 81.

Beneficially, a front-rear symmetrical gear cavity 82 is provided in the top wall of the swing cavity 23, a worm gear cavity 73 is provided in an end wall of one side of the gear cavity 82, and a through hole is provided between the two front and rear worm gear cavity 73 for rotation. A first worm 83 of the gear cavity 82, a third gear 75 meshing with the first gear 76 is fixedly provided on the outer surface of the first worm 83 in the gear cavity 82, and a top wall of the worm gear cavity 73 is provided A belt cavity 68 is provided, and a third rotation shaft 84 is rotatably provided between the belt cavity 68 and the worm gear cavity 73. The third rotation shaft 84 at the end of the worm gear cavity 73 is fixedly provided with the first worm 83. The first worm wheel 74 is engaged, and a first pulley 67 is fixedly disposed at the end of the third rotating shaft 84 in the belt cavity 68. The threaded sleeve 71 runs through the belt cavity 68, A second pulley 70 is fixedly disposed on the outer surface of the threaded sleeve 71, and the second pulley 70 and the first pulley 67 are drivingly connected and connected by a belt 69. The threaded sleeve 71 is provided with an up-and-down through-hole. A first threaded hole 72, and the first threaded rod 20 is screwed into the first threaded hole 72.

Advantageously, the gluing device 300 includes a right-side guide slide 58 provided in the right end wall of the swinging frame 24, and a guide slide 61 is slidably provided in the guide slide 58. A pressing spring 57 is elastically provided between the guide slider 61 and the left end wall of the guide groove 58. A glue application cavity 59 is provided in the right end wall of the guide slider 61, and the application wheel 60 is rotatably disposed at A through hole 62 is provided in the glue coating cavity 59, a top wall of the glue coating cavity 59, a glue storage tank 20 is fixedly arranged on the top wall of the swinging frame 24, and a bottom wall of the glue storage tank 2 is provided The blanking hole 63 communicates with the coating cavity 59.

Beneficially, the swinging device 400 includes an engaging cavity 64 provided in the swinging frame 24, and a fourth rotating shaft 46 rotatably provided in the engaging cavity 64. The front and rear ends of the fourth rotating shaft 46 pass through the ends. A swinging frame 24 is fixedly disposed on the front and rear walls of the swinging cavity 23, and a second worm gear 66 is fixedly disposed on the outer surface of the fourth rotating shaft 46 in the meshing cavity 64. The meshing cavity 64 is rotatably provided with A second worm 65 meshing with the second worm wheel 66 is provided with a second sliding cavity 44 in the top wall of the switching cavity 26, and a second sliding block 43 is slidably disposed in the second sliding cavity 44. A first motor 40 is fixedly disposed in the bottom wall of the second sliding block 43, a fourth gear 28 is fixedly disposed at the end of the output shaft of the first motor 40, and a second thread passing through left and right is disposed in the second sliding block 43. A hole 42 in which the second threaded hole 42 is internally screwed with a second threaded rod 42, the second threaded rod 42 is fixedly connected to the second worm 65, and the left end of the second threaded rod 42 is fixedly disposed A second motor 45 in the left end wall of the second sliding cavity 44 is power-connected.

Beneficially, the posting device 500 includes a third threaded hole 33 penetrating left and right provided in the first sliding block 32, and a third threaded rod 35 is internally connected to the third threaded hole 33. The end of the rod 35 penetrates deep into the rotation cavity 37 provided between the left and right connected first sliding cavities 34, and a third bevel gear 29 is fixedly disposed at the end. The rotation cavity 37 and the switching cavity 26 are provided with a first A fifth rotation shaft 38, a fifth gear 39 engaged with the fourth gear 28 is fixedly provided at the end of the fifth rotation shaft 38 in the switching cavity 26, and a fifth end of the fifth rotation shaft 38 in the rotation cavity 37 is fixed A fourth bevel gear 36 is provided, which meshes with the third bevel gear 29, and the roller 31 is rotatably disposed in a roller cavity 30 provided in the bottom wall of the first sliding block 32.

Beneficially, the adsorption device 600 includes a plurality of first sliding holes 55 arranged in a straight line and arranged symmetrically in the top wall of the swinging frame 24, and the first sliding holes 55 are slidably provided with the suction cups. 54 A first sliding rod 56 fixedly connected, the first sliding rod 56 is provided with a ventilation hole 55 penetrating vertically, and a return spring is elastically provided between the first sliding rod 56 and the top wall of the first sliding hole 55. 48. A communication pipe 49 communicating with the outside is provided in the left end wall of the first sliding hole 55, and a second sliding hole 53 penetrating the communication pipe 49 is provided in the end wall of the first sliding cavity 34. A second sliding rod 50 is slidably disposed in the second sliding hole 53, and a first resetting device 51 is elastically disposed between the second sliding rod 50 and an end wall of the second sliding hole 53. Air holes 52 penetrating vertically are provided in the slide bar 50.

Advantageously, the hydraulic mechanism 700 includes a third sliding hole 16 provided in the bottom wall of the storage cavity 11, and a third sliding hole 16 is slidably provided in the third sliding hole 16 and is fixedly connected to the ejection plate 13. A sliding rod 14, a second resetting device 15 is elastically provided between the third sliding rod 14 and an end wall of the third sliding hole 16, and a fourth sliding hole with an upward opening is provided on the right side of the top wall of the body 10. 19, a fourth sliding rod 17 is slidably disposed in the fourth sliding hole 19, and a hydraulic pipe 18 is provided between the fourth sliding hole 19 and the third sliding hole 16.

Beneficially, rollers 12 are symmetrically arranged on the front and rear walls of the fuselage 10 to facilitate movement of the fuselage 10.

The fixed connection method described in this embodiment includes, but is not limited to, methods such as bolt fixing and welding.

The sequence of mechanical actions of the entire device:

1. Start the first motor 40, thereby driving the fourth gear 28 to rotate, thereby driving the fifth gear 27 to rotate, and thereby driving the second bevel gear 80 to rotate, thereby driving the first bevel gear 78 Rotation, thereby driving the first gear 76 to rotate, thereby driving the third gear 75 to rotate, thereby driving the first worm 83 to rotate, thereby driving the first worm wheel 74 to rotate, thereby driving the first pulley 67 rotation, thereby driving the second pulley 70 to rotate, thereby driving the threaded sleeve 71 to rotate, thereby driving the sliding frame 22 to move up along the first threaded rod 21, and at this time, the advertisement paper is face up It is placed above the pushing plate 13, at this time, the first motor 40 is started to reversely drive the sliding frame 22 to move downward;

2. The sliding frame 22 moves down to drive the fourth sliding rod 17 to move downward, thereby squeezing the hydraulic oil in the hydraulic pipe 18 to squeeze the third sliding rod 14, and at this time, the third sliding rod The 14 upward movement causes the advertisement paper to move up to abut the suction cup 54. At this time, the first slide bar 56 moves up to compress the return spring 48. At this time, the suction plate 54 sucks the advertisement paper firmly. At this time, the fuselage 10 moves to the wall surface, the application wheel 60 abuts against the wall surface, and at this time, the guide slider 61 moves to the left, thereby driving the through hole 62 to the left and the blanking hole 63. Align, at this time, the glue in the glue storage tank 20 flows on the application wheel 60;

3. At this time, the first motor 40 is started again, thereby driving the fourth gear 28 to rotate, thereby driving the fifth gear 27 to rotate, and thereby driving the second bevel gear 80 to rotate, thereby driving the first The bevel gear 78 rotates, thereby driving the first gear 76 to rotate, thereby driving the third gear 75 to rotate, thereby driving the first worm 83 to rotate, thereby driving the first worm gear 74 to rotate, thereby driving the first A pulley 67 rotates, thereby driving the second pulley 70 to rotate, thereby driving the threaded sleeve 71 to rotate, thereby driving the sliding frame 22 to move up the first threaded rod 21, and at this time, the application wheel 60 moves along the wall, so that the glue is evenly spread on the wall;

4. When the slide frame 22 is moved to the upper edge of the position to be pasted, the second motor 45 is started, thereby driving the second threaded rod 41 to rotate, thereby driving the second slide block 43 to move to the right, As a result, the fourth gear 28 is brought into mesh with the fifth gear 39, and the second threaded rod 41 drives the second worm 65 to rotate. At this time, because the second worm 66 cannot rotate, the second The threaded rod 65 drives the swing frame 24 to rotate around the second worm wheel 66, thereby driving the back of the advertising paper to abut against the wall surface;

5. At this time, the rotation of the first motor 40 drives the fourth gear 28 to rotate, thereby driving the fifth gear 39 to rotate, thereby driving the fourth bevel gear 36 to rotate, thereby driving the third bevel gear 29 turns, thereby driving the third threaded rod 35 to rotate, thereby driving the first slide block 32 to move, thereby driving the roller 31 to abut against the advertisement paper and moving, when the first slide block 32 moves To the outermost side of the first sliding cavity 34, at the same time, the first sliding block 32 is in abutment with the second sliding rod 50, the air hole 52 moves to the right and communicates with the communication pipe 49, and the suction cup 54 is now The internal space communicates with the external air pressure, the suction cup 54 becomes ineffective and separates from the advertisement paper. At this time, the advertisement paper is pasted, and the above steps are repeated to gradually implement the advertisement paper.

The above embodiments are only for explaining the technical concept and characteristics of the present invention, and the purpose thereof is to enable those skilled in the art to understand and implement the content of the present invention, but not to limit the protection scope of the present invention. Any equivalent change or modification made according to the spirit and essence of the present invention should be covered by the protection scope of the present invention.

1. An The automatic posting device for wall advertisement paper, comprising a main body and a sliding frame that can be slid up and down above the main body, characterized in that a bottom cavity of the sliding frame is provided with a swing chamber with an opening downward. A lifting device capable of driving the sliding frame to move up and down is provided in the top wall of the swing cavity, and the lifting device utilizes a threaded sleeve provided in the sliding frame to rotate forwardly and symmetrically with a front-rear symmetrical first A threaded rod cooperates to drive the sliding frame to move up and down; a swinging frame is swingably arranged in the swinging cavity, and a gluing device is provided in the right end wall of the swinging frame. The gluing device accompanies the lifting device to drive the application wheel to apply the glue evenly on the wall surface. It is convenient for advertisement posting, a swinging device for swinging the swinging frame is provided in the right end wall of the swinging frame, and a first sliding cavity is symmetrically provided in the bottom wall of the swinging cavity, and the first sliding cavity and its end A posting device is provided in the wall, and the posting device includes a first sliding block slidably disposed in a first sliding cavity, and the first sliding block drives a roller provided in the bottom wall of the first sliding block to be rotatable. Move the advertising paper on the wall; an adsorption device is arranged in the bottom wall of the swing frame, and the adsorption device uses the sucker that is slidably arranged in the bottom wall of the swing frame to adsorb the advertisement paper, and then cooperates with the swing device to drive the advertisement paper from the horizontal direction to The vertical direction, so that the advertising paper is attached to the wall surface. A storage cavity with an upward opening is provided in the top wall of the fuselage, and a push plate is slidably arranged in the storage cavity. A hydraulic mechanism provided in the bottom wall of the storage cavity moves up and down under the action of the hydraulic mechanism, thereby driving the advertisement paper to move upward and cooperating with the adsorption device to adsorb the advertisement paper on the suction cup.

2. The automatic posting device for wall advertisement paper according to claim 1, wherein said lifting device further comprises a transmission cavity provided in the top wall of said swinging frame, and said transmission cavity is rotatably provided with A first rotating shaft extending forward and backward, a first bevel gear is fixedly disposed on an outer surface of the first rotating shaft in the transmission cavity, and front and rear ends of the first rotating shaft protrude from the outside of the swing frame, and the first end is fixedly provided with a first A gear, a switching cavity is provided in the bottom wall of the transmission cavity, and a second rotating shaft is rotatably provided between the switching cavity and the transmission cavity, and the end of the second rotating shaft in the transmission cavity is fixed with The second bevel gear meshed by the first bevel gear is described.

3. The automatic posting device for wall advertisement paper according to claim 1, wherein a front-rear symmetrical gear cavity is provided in the top wall of the swing cavity, and a worm gear cavity is provided in one end wall of the gear cavity. A first worm penetrating the gear cavity is provided between the two worm wheel cavities, and a second gear meshing with the first gear is fixed on the outer surface of the first worm in the gear cavity. A belt cavity is provided in the top wall of the worm gear cavity, and a third rotation shaft is rotatably provided between the belt cavity and the worm gear cavity. The third rotation shaft end in the worm gear cavity is fixedly provided with the first worm. The first worm gear that is engaged, a first pulley is fixedly disposed at the end of the third rotating shaft in the belt cavity, the threaded sleeve penetrates the belt cavity, and the outer surface of the threaded sleeve in the belt cavity is fixedly disposed There is a second pulley, and the second pulley and the first pulley are connected by a belt transmission. The threaded sleeve is provided with a first threaded hole penetrating up and down, and the first threaded rod is threadedly connected. In the first threaded hole.

4. The automatic posting device for wall advertisement paper according to claim 1, characterized in that the glue coating device comprises a guide chute with a right opening in the right end wall of the swing frame, and the guide A guide slider is slidably arranged in the chute, and a top pressure spring is elastically provided between the guide slider and the left end wall of the guide chute, and a rubber coating cavity is provided in the right end wall of the guide slider. The application wheel is rotatably disposed in the glue application cavity, a through hole is provided in the top wall of the glue application cavity, a glue storage tank is fixedly arranged on the top wall of the swing frame, and the bottom wall of the glue storage tank is fixed. A blanking hole is provided to communicate with the glue application cavity.

5. The automatic posting device for wall advertisement paper according to claim 1, wherein the swinging device comprises a meshing cavity provided in the swinging frame, and a fourth rotating shaft provided in the meshing cavity is rotatable. The front and rear ends of the fourth rotating shaft are fixedly arranged on the front and rear walls of the swinging cavity through the swinging frame, and a second worm gear is fixedly provided on the outer surface of the fourth rotating shaft in the meshing cavity. A second worm that meshes with the second worm wheel is rotatably provided in the cavity, a second sliding cavity is disposed in the top wall of the switching cavity, and a second sliding block is slidably disposed in the second sliding cavity. A first motor is fixedly disposed in the bottom wall of the second sliding block, a third gear is fixedly disposed at the end of the first motor output shaft, and second and left threaded holes are formed in the second sliding block. A second threaded rod is internally connected to the second threaded hole, the second threaded rod is fixedly connected to the second worm, and a left end of the second threaded rod is fixedly disposed at a left end of the second sliding cavity. Second motor power connection in the wall.

6. The automatic posting device for wall advertisement paper according to claim 1, wherein the posting device comprises a third threaded hole that passes through the left and right sides of the first sliding block, and the third threaded hole A third threaded rod is connected to the internal thread, and the end of the third threaded rod penetrates into a rotation cavity provided between the left and right connected first sliding cavities, and a third bevel gear is fixedly arranged at the end. A fifth rotation shaft is rotatably provided between the switching chambers, and a fourth gear meshing with the third gear is fixedly provided at the end of the fifth rotation shaft in the switching chamber, and the fifth rotation shaft end in the rotation chamber is fixed. A fourth bevel gear meshed with the third bevel gear is fixedly disposed, and the roller is rotatably disposed in a roller cavity provided in a bottom wall of the first sliding block.

7. The automatic posting device for wall advertisement paper according to claim 1, wherein the adsorption device comprises a plurality of first sliding holes distributed along a straight line, which are symmetrically arranged in the top wall of the swing frame. A first sliding rod fixedly connected to the suction cup is slidably disposed in the first sliding hole, and a ventilation hole penetrating vertically is provided in the first sliding rod, and the first sliding rod and the first sliding a return spring is elastically provided between the top walls of the holes, a communication pipe communicating with the outside is provided in the left end wall of the first sliding hole, and a second pipe penetrating the communication pipe is provided in the end wall of the first sliding cavity. a sliding hole, a second sliding rod is slidably disposed in the second sliding hole, and a first resetting device is elastically provided between the second sliding rod and an end wall of the second sliding hole, and the second sliding rod An air hole penetrating vertically is provided in the inside.

8. The automatic posting device for wall advertisement paper according to claim 1, wherein the hydraulic mechanism comprises a third sliding hole provided in the bottom wall of the storage cavity, and the third sliding hole is slidable. A third sliding rod fixedly connected to the pushing plate is provided, and a second resetting device is elastically provided between the third sliding rod and an end wall of the third sliding hole, and the right side of the top wall of the fuselage is provided. A fourth sliding hole with an upward opening is provided. A fourth sliding rod is slidably disposed in the fourth sliding hole. A hydraulic tube is provided between the fourth sliding hole and the third sliding hole.

9. The automatic posting device for wall advertisement paper according to claim 1, wherein the front and rear walls of the fuselage are symmetrically provided with rollers on the left and right sides to facilitate the movement of the fuselage.
